(19) United States
(12) Patent Application Publication
(10) Pub. No.: US 2012/0027672 A1
(43) Pub. Date: Feb. 2, 2012

(54) HYDROGEN-GENERATING MATERIAL AND METHOD FOR GENERATING HYDROGEN

(75) Inventors: HONG-WEN WANG, Tao-Yuan (TW); HSING-WEI CHUNG, Tao-Yuan (TW); HSIN-TE TENG, Taichung City (TW)

(73) Assignee: CHUNG YUAN CHRISTIAN UNIVERSITY, Tao-Yuan (TW)

(21) Appl. No.: 13/110,860

(22) Filed: May 18, 2011

Related U.S. Application Data
(63) Continuation-in-part of application No. 12/845,634, filed on Jul. 28, 2010.

(51) Int. Cl. C01B 3/08; B82Y 30/00

(52) U.S. Cl. 423/658; 423/657; 977/902

(57) ABSTRACT

A hydrogen-generating material and method for generating hydrogen are provided. A plurality of metal particles and a plurality of modifier particles are mixed and than reacted with water to generate hydrogen. The metal particles are made of material including aluminum or aluminum alloy or combination thereof. The modifier particles preferably comprise titanium dioxide (TiO₂), chromium trioxide (Cr₂O₃), cobalt tetroxide (CO₃O₄), nickel oxide (NiO), iron oxide (Fe₂O₃), and/or iron tetroxide (Fe₃O₄) particles, and the average particle size of the modifier particles is preferably between about 10 nm to about 50 nm.

### CROSS-REFERENCE TO RELATED APPLICATIONS

This application is a continuation-in-part of co-pending U.S. application Ser. No. 12/845,634 (Att. Docket CH8424P), filed Jul. 28, 2010 and entitled HYDROGEN-GENERATING MATERIAL AND METHOD FOR PRODUCING HYDROGEN, the entire contents of which are incorporated herein by reference.

### BACKGROUND OF THE INVENTION

1. Field of the Invention

The present invention relates to methods of generating hydrogen and hydrogen-generating materials.

2. Description of Related Art

Hydrogen is considered to be the best fuel for fuel cells in clean energy generation because of its light weight, high energy density, and non-pollution.¹ However, the production and storage of hydrogen gas remains challenging today. There are many ways to produce hydrogen, such as direct decomposition or partial oxidation of hydrocarbon compounds,²⁻³ steam reforming of hydrocarbons,³⁻⁴ chemical hydrides reacting with water⁵, splitting water using metal-oxide catalysts under solar energy,⁶⁻¹⁰ and metal aluminum reacting with aqueous alkaline solution,¹¹⁻¹⁶ etc. However, drawbacks do exist in above methods. The direct decomposition or partial oxidation of hydrocarbon reactants require an elevated temperature and produces a considerable amount of carbon monoxide (CO)) and byproducts. Steam reforming of hydrocarbons exhibits advantages in producing hydrogen. In particular, the reforming of methanol could be accomplished at a lower temperature and produced one order of magnitude less carbon monoxide (CO) than the other hydrocarbons³⁻⁴. However, the steam reforming reaction is endothermic, and an external heat supply is required to proceed the reaction. At the same time, the byproduct of carbon monoxide (CO) required further attention to minimize Chemical hydrides such as LiBH₄, NaBH₄, KBH₄, NaAlH₄, LiH, NaH, and MgH₂ react with water directly and generate large amounts of pure hydrogen under ambient conditions. The reaction does not require additional energy and has no carbon monoxide (CO) byproduct⁵. However, the deactivation of the catalyst (Pt, Ru, etc.), treatment of the hydroxide byproducts, proper control of reaction rate, and the high price of reactants are the challenges in commercialization. Splitting water using metal-oxide catalysts such as TiO₂ under solar energy demonstrates a promising route for hydrogen generation⁶⁻⁸. In the photoelectrochemical water-splitting, hydrogen and oxygen are produced in an electrochemical cell by the incidence of solar energy on the photoelectrode (TiO₂), where electron-hole pairs are produced. This method has drawn many attentions since its discovery⁶. However, the hydrogen generation efficiency over the bare TiO₂ is low, mainly due to the fast recombination of electron/hole pairs.⁷⁻⁸ Noble metal such as Pt or semiconductor such as CdS modified TiO₂ has been proven to be very effective in overcoming this problem⁹⁻¹⁰. However, the hydrogen generation rate from this method is a few to tens μmole per hour per cm²⁻⁷. A higher hydrogen generation rate for high-energy output is required. The metal Al reacting with aqueous alkaline solution to generate hydrogen is a well-known reaction ¹¹. The direct reaction of metal Al with pure water is difficult because of a dense passive oxide film Al₂O₃ that covers the Al surface when fresh metal Al is exposed to an oxidation environment. Metal Al could continuously react with water as soon as the Al₂O₃ layer was attacked by the acid or alkaline solutions. However, the environmental pollution and the easy passivation of metal Al surface are the major concerns of this method. A new way to realize the direct reaction of metal Al and pure water was proposed by Chaklader¹², who stated that the direction reaction of metal Al with tap water by using α-Al₂O₃, γ-Al₂O₃, or carbon powders as the additives through mechanical mixing could easily generate hydrogen under ambient conditions. Zeng et al.¹³⁻¹⁵ confirmed the role of catalyst γ-Al₂O₃ and the enhancement effect of warm temperature on the hydrogen generation in the system of Al and pure water. Zeng et al. then described the concept of “ceramic oxide surface modification of metal Al powder” and proposed the mechanism of hydrogen generation in this system.^{13,15} That is, the surface of metal Al particles was modified with ceramic oxide powders such as γ-Al₂O₃. The γ-Al₂O₃-modified Al powders (GMAP) could almost completely react with pure water and generate hydrogen at room temperature under atmospheric pressure.^{13,15} Although temperature may promote the reaction speed, the merit of energy production from this method was reduced. Despite the success of explanation of hydrogen generation by using uniform corrosion model, the use of pressing and calcination process reduced the advantages of this method. In addition, the milling effect and the reaction duration for hydrogen generation have not been studied in detail in Chaklader's patents.¹² A further improvement to promote the reaction of metal Al in water is required. Accordingly, it would be advantageous to provide a novel method and novel material for more effectively producing hydrogen. [References: 1. Hoffmann P. “Tomorrow's energy: hydrogen, fuel cells, and the prospects for a cleaner planet” 1 Ed., USA, MIT Press, 99-141 (2002); 2. Cheng, W. H., Shiau, C. Y., Liu, T. H., Tung, H. L., Lu, J. F. and Hsu, C. C. “Promotion of Cu/Cr/Mn Catalyst by Alkali Additives in Methanol Decomposition” Appl. Catal. A, 170 (2), 215-224 (1998); 3. Brown, L. F. “A comparative study of fuels for on-board hydrogen production for fuel-cell-powdered automobiles” Int. J. Hydrogen Energy, 26 (4), 381-397 (2001); 4. Palo, D. R., Dagle, R. A. and Holladay, J. D., “Methanol Steam Reforming for Hydrogen Production” Chem. Rev., 107, 3992-4021 (2007); 5. Wee, J. H., “A Comparison of Sodium Borohydride as a Fuel for Proton Exchange Membrane Fuel Cells and for Direct Borohydride Fuel Cells” J. Power Sources, 155 (2), 329-339 (2006); 6. Fujishima, A., Honda, K. “Electrochemical photolysis of water at a semiconductor electrode”. Nature 238, 37-38 (1972); 7. Kitano, M., Tsujimaru, K. and Anpo, M., “Hydrogen Production using Highly Active Titanium Oxide-based Photocatalysts” Top Catalyst 49, 4-17 (2008); 8. Krol, R. van de., Liang, Y. and Schoonman, “Solar hydrogen production with nanostructured metal oxides” J. Mater. Chem., 18, 2311-2320 (2008); 9. Jang, S., Kim, H. G., Joshi, U. A., Jang, J. W. and Lee, J. S. “Fabrication of CdS nanowires decorated with TiO₂ nanoparticles for photocatalytic hydrogen production under visible light irradiation” Int. J. Hydrogen Energy 33, 5975-5890 (2008); 10. Siemon, U., Bahnemann, D., Testa, Juan J., Rodriguez, D., Litter, Marta I., Bruno, N., “Heterogeneous photocatalytic reactions comparing TiO₂ and Pt/TiO₂” J. Photochem. Photobiol. A: Chem. 148, 247-255 (2002); 11. Smith, I. E., “Hydrogen generation by means of the aluminum/water reaction” J. Hydronautics 6 (2), 106-109 (1972); 12. Chaklader, A., “Hydrogen Generation from Water Split Reaction,” U.S. Pat. No. 6,440,385 (2002), and U.S. Pat. No. 6,582,676 (2003); 13. Deng, Z. Y., Ferreira, J. M. F. and Sakka, Y., “Hydrogen-Generation Materials for Portable Applications” J. Am, Ceram. Soc., 91 (12), 3825-3834 (2008); 14. Deng, Z. Y., Liu, Y. F., Tanaka, Y., Zhang, H. W., Ye, J. H. and Kagawa, Y., “Temperature Effect on Hydrogen Generation by the Reaction of γ-Al₂O₁-Modified Al Powder with Distilled Water,” J. Am. Ceram. Soc., 88 (10), 2975-2977 (2005); 15. Deng, Z. Y., Ferreira, J. M. F., Tanaka, Y. and Ye, J. H., “Physicochemical Mechanism for the Continuous Reaction of γ-Al₂O₃ Modified Al Powder with Water,” J. Am. Ceram. Soc., 90 (5), 1521-1526 (2007).]

### SUMMARY OF THE INVENTION

An object of the present invention is to provide novel methods and novel materials for producing hydrogen. In addition, the novel methods or materials are beneficial to the environment.

According to the object, one embodiment of the present invention provides a hydrogen-generating material for generating hydrogen by exposing it to water. The hydrogen-generating material comprises a plurality of metal particles and a plurality of modifier particles mixed with the metal particles. The metal particles are made of material including aluminum or aluminum alloy or composite combination thereof. The modifier particles preferably comprise titanium dioxide (TiO₂), chromium trioxide (Cr₂O₃), cobalt tetroxide (Co₃O₄), nickel oxide (NiO), iron oxide (Fe₂O₃), and/or iron tetroxide (Fe₃O₄) particles, and the average particle size of the modifier particles is preferably between about 10 nm to about 50 nm.

According to the object, one embodiment of the present invention provides a method for generating hydrogen. The method comprises: mixing the above-mentioned metal particles with the above-mentioned modifier particles to generate a hydrogen-generating material; and reacting the hydrogen-generating material with water to generate hydrogen.

### BRIEF DESCRIPTION OF THE DRAWINGS

FIG. 1 shows the hydrogen generation rate of three different metal Al powders listed in Table 1 at the same processing condition, according to embodiments of the present invention.

FIG. 2 shows hydrogen generation rate curves of Al:TiO₂(P90) under variant milling durations (ball milling and hand milling) and fixed weight ratio 1:1, according to embodiments of the present invention.

FIG. 3 shows the hydrogen generation rate curves of Al modified by variant TiO₂ powders under conditions 1 h ball milling (BM) duration and fixed weight ratio 1:1, according to embodiments of the present invention.

FIG. 4 shows the hydrogen generation rate curves of Al:Cr₂O₃ under variant ball milling (BM) or hand milling (HM) duration and fixed weight ratio 1:1, according to embodiments of the present invention.

FIG. 5 shows the hydrogen generation rate curves of Al:Fe₃O₄ under 3 minutes of hand milling (HM) and weight ratio 1:1, according to embodiments of the present invention.

FIG. 6 shows the hydrogen generation rate curves of Al:CO₃O₄ under variant ball milling (BM) or hand milling (HM) duration and fixed weight ratio 1:1, according to embodiments of the present invention.

FIG. 7 shows the hydrogen generation rate curves of Al:NiO under variant ball milling (BM) or hand milling (HM) duration and fixed weight ratio 1:1, according to embodiments of the present invention.

FIG. 8 shows the hydrogen generation rate curves of Al:TiO₂ (reagent) under hand milling 3 min (HM=3 min) and fixed weight ratio 1: according to embodiments of the present invention.

### DETAILED DESCRIPTION OF THE PREFERRED EMBODIMENT

Reference will now be made in detail to specific embodiments of the present invention. Examples of these embodiments are illustrated in accompanying drawings. While the invention will be described in conjunction with these specific embodiments, it will be understood that it is not intended to limit the invention to these embodiments. On the contrary, it is intended to cover alternatives, modifications, and equivalents as may be included within the spirit and scope of the invention as defined by the appended claims. In the following description, numerous specific details are set forth in order to provide a thorough understanding of the present invention. The present invention may be practiced without some or all of these specific details. In other instances, well-known process operations and components are not described in detail in order not to unnecessarily obscure the present invention. While drawings are illustrated in detail, it is appreciated that the quantity of the disclosed components may be greater or less than that disclosed, except when expressly restricting the amount of the components.

A preferred embodiment of the present invention provides a hydrogen-generating material for generating hydrogen by exposing it to water. The hydrogen-generating material comprises a plurality of metal particles and a plurality of modifier particles mixed with the metal particles. The metal particles are made of material including aluminum or aluminum alloy or composite combination thereof. The aluminum alloy is an alloy of pure aluminum and one or more alloy elements including iron, copper, manganese, magnesium, zinc, nickel, titanium, lead, tin, chromium, and combination thereof. In the embodiments of the present invention, the less weight ratio the alloy element is included in the aluminum alloy, the more amount of hydrogen gas is generated. Preferably, the average particle size of the modifier particles is nanoscale and the modifier particles are well mixed with the metal particles. The modifier particles comprise group 3 to group 12 transition metal oxide particles, preferably comprising period 4 transition metal oxide particles, i.e., scandium (Sc), titanium (Ti), vanadium (V), chromium (Cr), manganese (Mn), ferrum (Fe), cobalt (Co), nickel (Ni), copper (Cu), and/or zinc (Zn) metal oxide particles.

In an embodiment, the modifier particles preferably comprise titanium dioxide (TiO₂) particles, and for effectively generating hydrogen the average particle size of the titanium dioxide particles is preferably less than 25 nm. In other embodiments, the modifier particles may be preferably selected from a group consisting of titanium dioxide (TiO₂), chromium trioxide (Cr₂O₃), cobalt tetroxide (CO₃O₄), nickel oxide (NiO), iron tetroxide (Fe₃O₄), iron oxide (Fe₂O₃), and combination thereof, and the average particle size of the modifier particles is preferably between about 10 nm to 50 nm.

A method for producing hydrogen is provided according to an embodiment of the present invention. The method comprises: mixing the above-mentioned metal particles with the above-mentioned modifier particles to generate a hydrogen-generating material; and reacting the hydrogen-generating material with water to generate hydrogen and byproduct. For the case using the titanium dioxide as the modifier, the byproduct includes aluminum hydroxide Al(OH)₃ or aluminum oxide (Al₂O₃).

The reaction may be carried out by adding the hydrogen-generating material into the water or by other way, such as water-spilt system as taught by prior art. The mixing of the metal particles and the modifier particles may include a mechanically mixing process or a hand-mixing process. The mechanical mixing process may be a milling process, such as a ball-milling process, which is typically performed in a container filled with material to be ground plus the grinding medium, such that the material (for example, the metal particles and the modifier particles) are pulverized and mixed. The hand-mixing process may be performed by a mortarboard and a pestle.

Experiments of the present invention show that the generation of hydrogen from the reaction of hydrogen-generating material and water is dependent on sizes of metal Al powders, modifiers, size of the modifiers, weight ratio of metal particles to the modifier particles, and ball-milling durations. In one embodiment, the weight ratio of the metal particles to the modifier particles is between about 1:0.5 to about 1:2, and preferably between about 1:1 to about 1:1.5. In the preferred embodiment, the average particle size of the modifier particles is about 15 nm. The size of the metal particles typically is microscale, for example, but is not limited to this, between about 1 μm to about 100 μm. In a particular exemplary example, the average particle size of the metal particles is about 45 μm. In other embodiments of the present invention, the size of the metal particles may be nanoscale or blend of nanoscale with microscale. The dimension mentioned above is the size before the mixing process, and the size of the metal particles and the modifier particles may be altered after the mixing process.

Experiments were made to investigate the practicability of the hydrogen-generating material and method, and to identify the factors affecting the hydrogen generation. In the following experiments, TiO₂ nanopowders are used as a modifier for the metal Al powders in the reaction with ordinary tap water to generate hydrogen at ambient temperature and ambient pressure, i.e., 1 atm. Specifically, the present invention systematically investigates the effect of four different TiO₂ ceramic powders and other modifiers (also referred to “additives” or “catalysts”) such as Al(OH)₃, AlO(OH), α-Al₂O₃, γ-Al₂O₃, SiO₂, CaO, Fe₂O₃, WO₃, on the promotion of hydrogen generation in the reaction of metal Al powders and tap water.

Table 1 lists the specification and suppliers of the chemicals and reagent powders used in the present invention, where the specification including the purity and particle size of the metal Al powders and the modifiers. Table 2 shows effect of weight ratio of metal Al (c) powder to TiO₂ powder in the hydrogen production. The total reaction time was 18 h and all samples are ball-mixed for 1 h. Table 3 shows effect of modifiers and milling duration on the reaction of metal Al (c) and tap water. The total reaction time of H₂ production was 18 h for all modifiers, except the case of CaO, which was only 6 h. in addition, in each experiment 10 g of metal Al powders were ball-mixed with modifier powders including AlO(OH), Al(OH)₃, CaO, γ-M₂O₃, α-Al₂O₃, SiO₂, Fe₂O₃, WO₃ and TiO₂ in a plastic bottle with ZrO₂ balls for the durations from 7.5 minutes to 64 hours, except labeled with “No” and “3 min by hand,” where “No” means that metal Al powder and modifier were put into tap water without any mixing process, and “3 min by hand” means hand-mixing by mortarboard and pestle.

Three different metal Al powders were used and compared, as shown in Table 1, which referred as Al (a), (b) and (c), according to their specification and suppliers. The weight ratio of modified ceramic oxide powders to metal Al powders were varied from 0.1 to 20 for 1 g metal Al powders. After the ball-mixing process, 1 g of metal Al powders with the accompanied modifier powders were added into a 200 ml ordinary tap water (pH=6.24), which was sealed in a conical flask. The generated hydrogen was measured with a precision gas flow meter, where the output data was recorded in a notebook computer every second for 18 h automatically. Field-emission scanning electron microscopy (FESEM, Hitachi S-4100) was employed to characterize the morphologies of the powders.

### Factor—Morphologies of Metal Particles

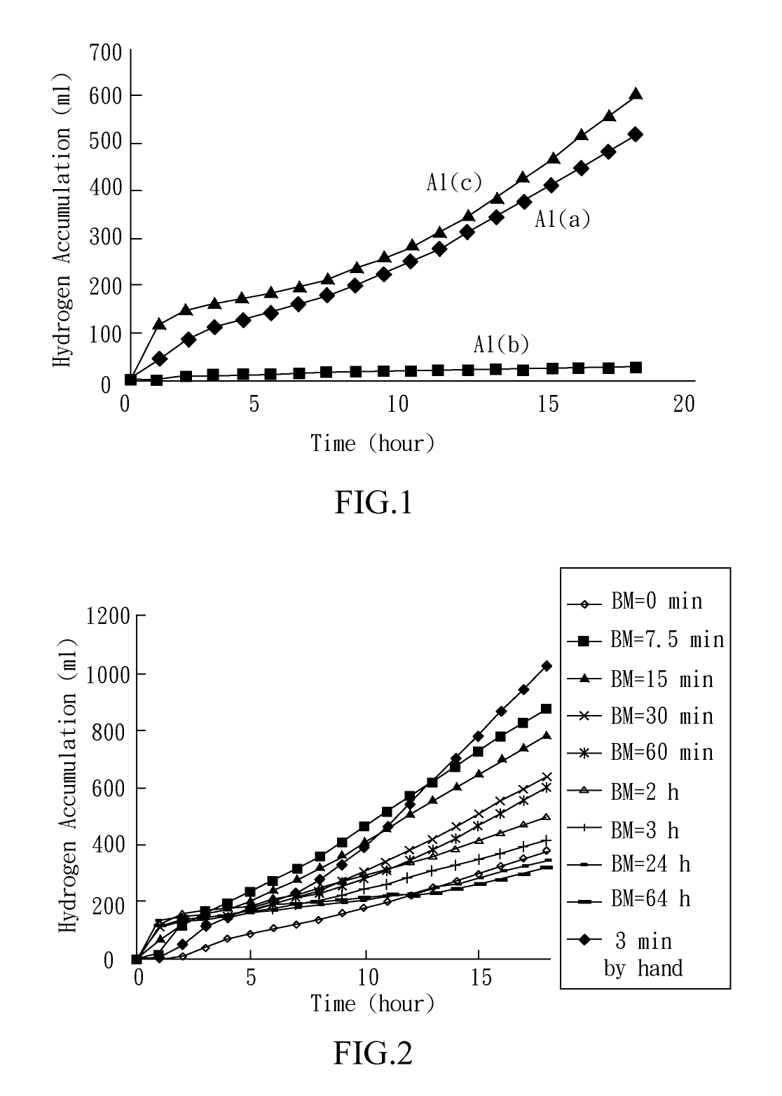

FIG. 1 shows the hydrogen generation rate of three different metal Al powders listed in Table 1 at the same processing condition. The different metal Al powders exhibited different hydrogen generation rate at the same condition, where the weight ratio to modifier (TiO₂, P90) was 1:1, and the ball-mixed duration was 1 h. It shows that the metal Al (c) powder generated the total H₂ volume greater than those of Al (a) and Al (b) in 18 h. It is considered that the metal Al (c) powder has the smallest particle size, therefore, highest surface area for reacting with water. Noticed that even TiO₂ P90 was effective on Al (a) and Al (c), it expedited little effect on Al (b) for hydrogen generation.

### Factor—Weight Ratio of Metal Al Powders to TiO₂ Modifier

Table 2 demonstrates the effect of weight ratio of metal Al (c) to TiO₂ was. Among these ratios, 1:1, 1:1.5, and 1:2 show good performance on the promotion of hydrogen generation. The highest hydrogen generation rate is 37.4 ml per hour per 1 g metal aluminum, which was obtained at weight ratio of metal Al to TiO₂ (P90) at 1:1.5. It is thought that less TiO₂ exhibits less catalytic effect and excessive TiO₂ powder prevents the reaction of metal Al powders and tap water.

### Factor—the Modifiers

As shown in Table 3, twelve modifier powders have been tested for their influence on the reaction of metal Al (c) powder to tap water. Among these tests, it was found that AlO(OH), CaO, γ-Al₂O₃, and TiO₂ were effective to promote hydrogen generation. The effectiveness of CaO was due to the increased basic value to pH=11 in the solution, which was originated from the dissociation of Ca(OH)₂. The effect of AlO(OH) and γ-Al₂O₃ was already demonstrated previously by Chaklader and Deng et al., and its mechanism was proposed. The experimental results show that the effectiveness of γ-Al₂O₃ could be realized at weight ratio 1:1, and more γ-Al₂O₃ did not promote this effect further. The effect of TiO₂ (P90) was also effective to promote the hydrogen generation in the reaction of metal Al (c) and tap water. In addition, TiO₂ (P90) exhibited slightly better effect than that of γ-Al₂O₁ at similar processing condition (1:1 weight ratio, ball-mixing 1 h).

### Factor—Sizes of TiO₂ Modifier

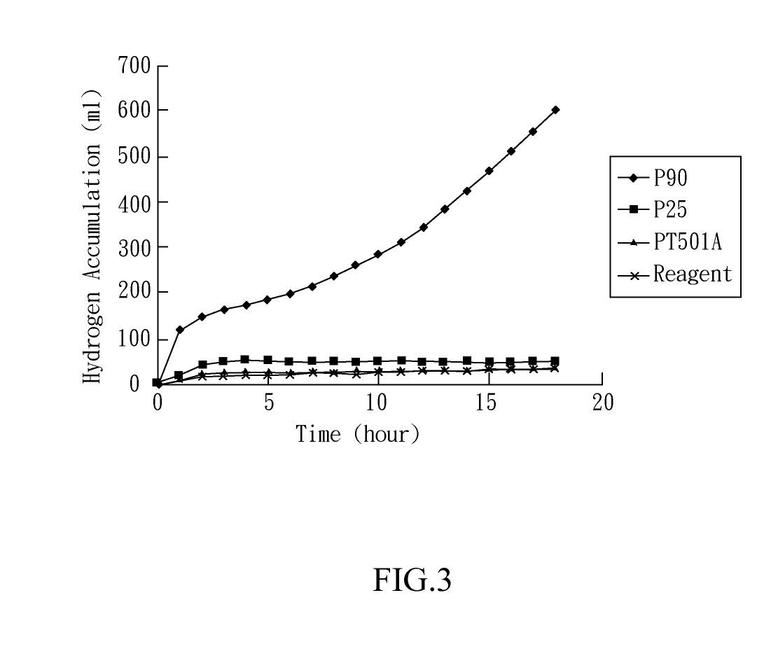

It is clear in Table 3 that the smaller particle size of TiO₂ such as P90 greatly facilitates the total H, generation from the reaction of metal Al (c) and water. However, larger particle size of TiO₂ such as P25, PT501A and reagent powders did not give similar effect at the weight ratio (1:1) to metal Al (c) powder. It is understandable that large surface area of P90 provides effective catalytic effect on the reaction of metal Al powders and water. But the slightly larger size of TiO₂ such as P25 did not exhibit effectiveness on the reaction, as shown in FIG. 3.

### Factor—Ball-Milling Duration

Ball-milling duration was varied from 7.5 min to 64 hour for investigating its influence. For clearly revealing the ball-milling duration effect, FIG. 2 shows the hydrogen generation rate curves of Al:TiO₂(P90) under variant ball milling (BM) durations or hand-mixing duration and weight ratio 1:1. All results are listed in Table 3. For simplicity, hydrogen generation rate curves of other metal/modifier materials are omitted but the results are also listed in Table 3.

FIG. 2 shows a tendency that for TiO₂(P90), longer ball-milling duration will deteriorate the hydrogen generation rate and TiO₂(P90) with 7.5 min ball-milling duration generates the greatest quantity of total hydrogen and has highest average hydrogen generation rate.

As shown in FIG. 3, Al:TiO₂(P90) has a hydrogen generation rate much higher than that of Al:TiO₂(P25), Al:TiO₂(PT501A), and TiO₂(Reagent). This result indicates that the particle size of the modifier particle plays an important role in the hydrogen reaction mechanism.

In addition, Table 3 shows that longer ball-milling duration will deteriorate the effectiveness of TiO₂ as well as those of γ-Al₂O₃. Longer ball-milling results in an inferior total H₂ production in 18 h. This is an unusual phenomenon, which is contradictive to what has known previously for the influence of ball-mixing time for the γ-Al₂O₃ on the hydrogen generation. In fact, when ball-milling was not employed and mixing was done only by using mortarboard and pestle for 3 minutes, the total hydrogen generation volume was even better in the case of TiO₂ P90 and was still very effective for γ-Al₂O₃ in the period of 18 h, as shown in Table 3. However, if γ-Al₂O₃ or TiO₂ (P90) and metal Al (c) are directed added into tap water without any ball-milling process, then the generated H₂ in 18 It was decreased, but still quite effective (>20 ml/h per g Al). This cannot be explained by Deng's mechanism and a new reaction mechanism is required.

The present invention proposes a pitting mechanism to explain the above observations as follows. The generation of hydrogen is dependent on the duration of the milling process, such as ball-milling process, when the duration is sufficient to completely remove an oxide layer deposited on the surface of the metal particles, a great quantity of hydrogen is generated in a relatively short period of time, for example, 1 hour; however, once the surface of the metal particles is encapsulated by the metal oxide byproduct (such as aluminum hydroxide) of the reaction, the hydrogen generation is stopped and a portion of each metal particle will be remained and not reacted.

In contrast, when the duration is insufficient to completely remove the oxide layer deposited on the surface of the metal particles, i.e., a portion of the oxide layer remained, the generation of hydrogen will conform to the pitting mechanism and hydrogen is uniformly generated in a relatively long period of time until the metal particle is totally reacted.

Accordingly, it is practicable to control the duration of the milling process to remove a portion of an oxide layer deposited on the surface of each of the metal particles, such that the generation of hydrogen conforms to the pitting mechanism and hydrogen is uniformly generated in a relatively long period of time until the metal particle is totally reacted.

In addition to titanium dioxide, other transition metal oxide particles are employed as the modifiers to promote hydrogen generation. The following embodiments of this invention use other period 4 transition metal oxide particles, including chromium trioxide (Cr₂O₃), iron tetroxide (Fe₃O₄), cobalt tetroxide (Co₃O₄), and nickel oxide (NiO), as the modifier for the metal Al powders in the reaction with pure water to generate hydrogen at ambient temperature. Notice that the procedures of hydrogen generation for the following embodiments are same as that described in embodiments of titanium dioxide except the tap water is replaced by deionized water.

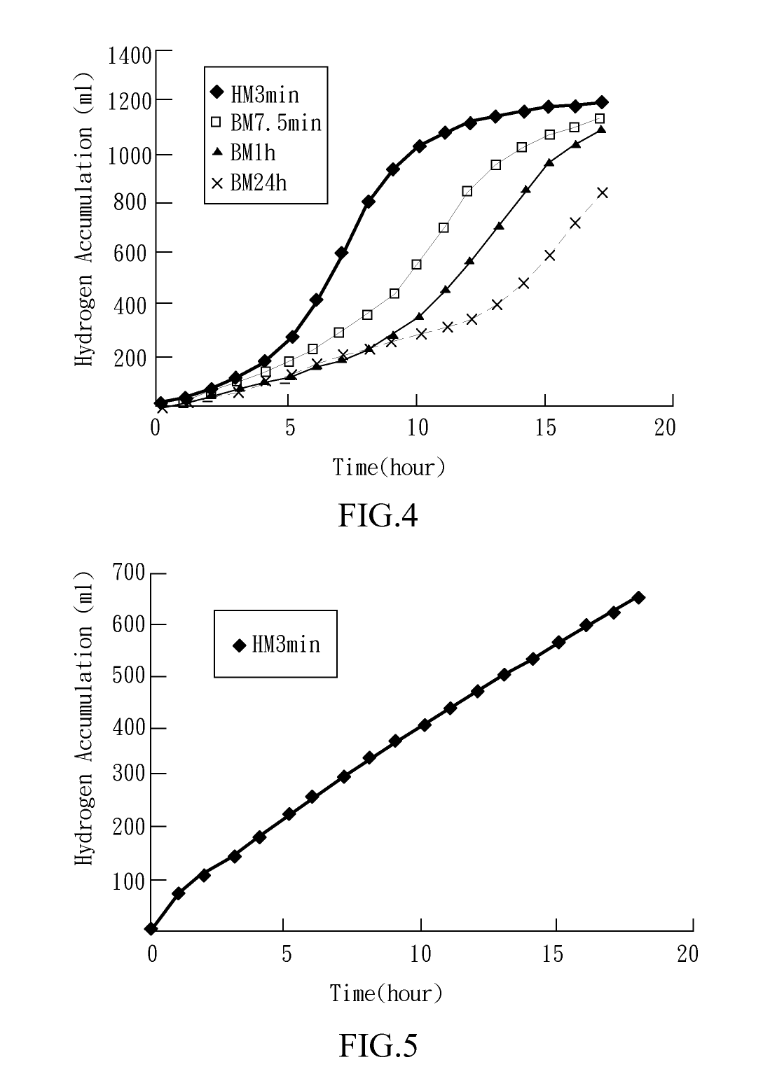

FIG. 4 shows the hydrogen generation rate curves of Al:Cr₂O₃ under variant ball milling (BM) or hand milling (HM) duration and fixed weight ratio 1:1, The curves show that longer ball-milling duration will deteriorate the hydrogen generation rate and Cr₂O₃ with 3 min hand-milling duration generates the greatest quantity of total hydrogen and has highest average hydrogen generation rate greater than 40 ml/h·g (per hour and per gram of aluminum) in a period of 18 h. The average particle size of the Cr₂O₃ powders is about 50 nm. FIG. 5 shows the hydrogen generation rate curves of Al:Fe₃O₄ under 3 minutes of hand milling (HM) duration and weight ratio 1:1. The curve shows that the average hydrogen generation rate is greater than 20 ml/h·g and is effective. The average particle size of the Fe₃O₄ powders is about 10 nm.

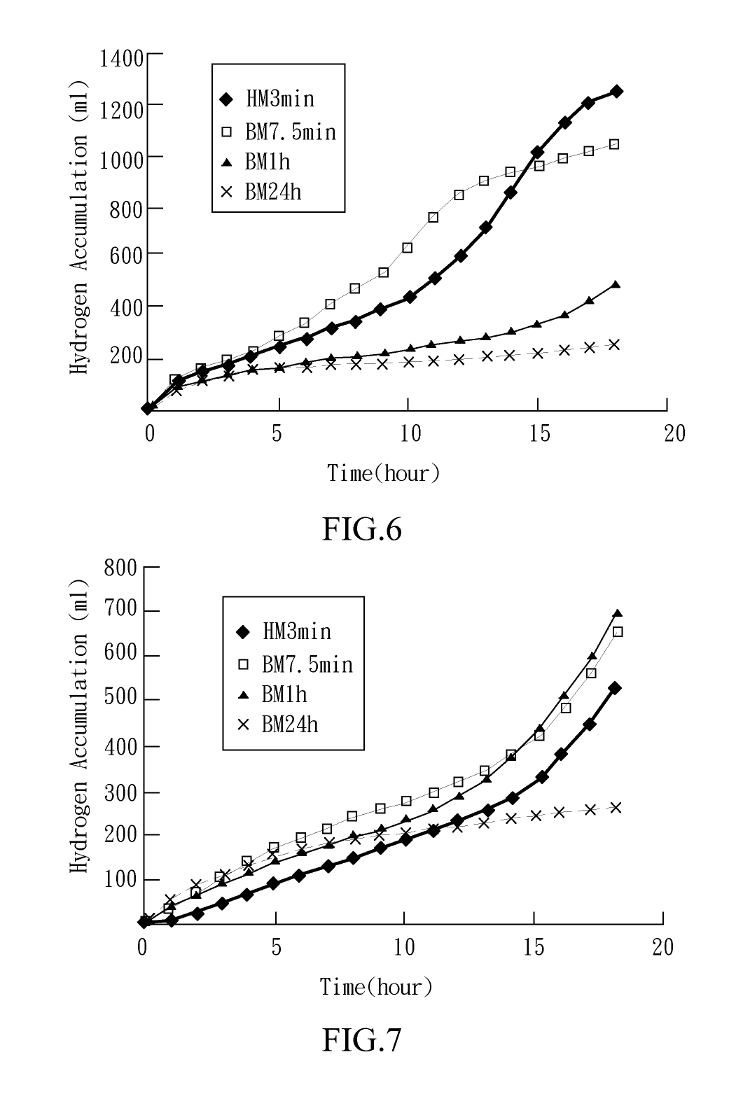

FIG. 6 shows the hydrogen generation rate curves of Al:CO₃O₄ under variant ball milling (BM) or hand milling (HM) duration and fixed weight ratio 1:1. The curves show that longer ball-milling duration will deteriorate the hydrogen generation rate and CO₃O₄ with 7.5 min ball-milling duration generates the greatest quantity of total hydrogen and has highest average hydrogen generation rate greater than 40 ml/h, g (per hour and per gram of aluminum) in a period of 18 h. The average particle size of the CO₃O₄ powders is about 30 nm.

FIG. 7 shows the hydrogen generation rate curves of Al:NiO under variant ball milling (BM) or hand milling (HM) and fixed weight ratio 1:1. The curves show that longer ball-milling duration will deteriorate the hydrogen generation rate and NiO with 7.5 min ball-milling duration generates the greatest quantity of total hydrogen and has highest average hydrogen generation rate greater than 20 ml/h·g (per hour and per gram of aluminum) in a period of 18 h. The average particle size of the NiO powders is about 50 nm.

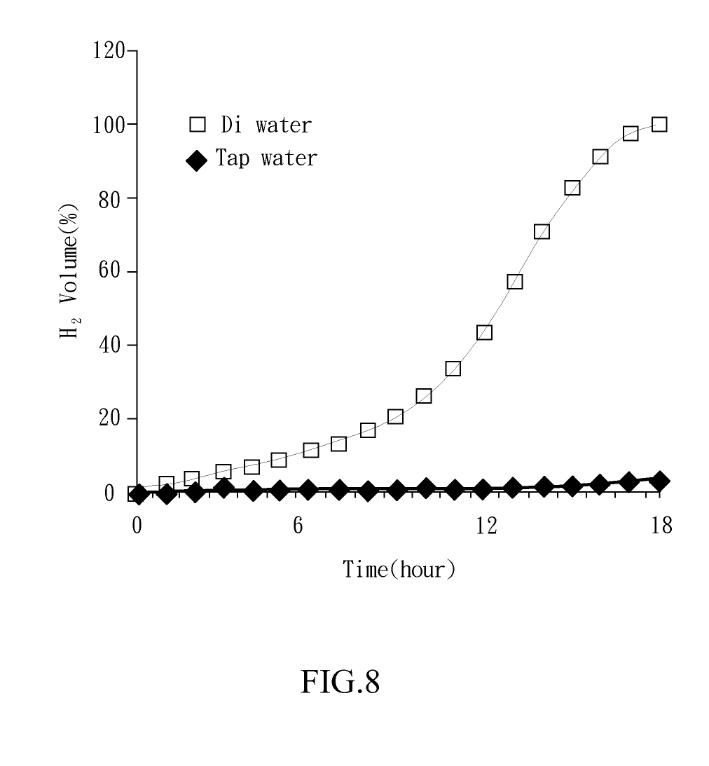

Additional experiments of this invention show that the elevated temperature for reaction can promote the hydrogen generation rate. For Al:TiO₂ system, the hydrogen generation rate at 35° C. is greater than that at 30° C., which is greater than that at 25° C. The same result can be also observed in other Al:transition metal oxide systems. In addition, experiments found that for the same hydrogen-generating material, the hydrogen generation rate in deionized water is greater than that in tap water. Moreover, the factor of water quality may contribute more importance than expected. FIG. 8 shows the hydrogen generation rate curves of Al:TiO₂ (reagent) under hand milling 3 min (HM=3 min) and fixed weight ratio 1:1. In theory, one gram of Al powder can generate 1362 mL of hydrogen, and 100% H₂ volume means that all Al powders have completely reacted to hydrogen. The curves show that when deionized (DI) water was used for generation of hydrogen, the TiO₂ modifier (reagent, size=300-450 nm) will be effective to facilitate the reaction of metal Al and water. This indicates that for Al:TiO₂ system, the average particle size of TiO₂ particles could be as large as, or less than, about 300-450 nm when reacting in deionized water.

Embodiments of the present invention have demonstrated that nanosized TiO₂, Cr₂O₃, Co₃O₄, and NiO powders exhibited a strong effect on the promotion of hydrogen generation from the reaction of metal Al powders and tap water or deionized water. The present invention provides method and material for generating hydrogen in a simple, cost effective, and safe manner. The hydrogen reaction of the present invention can be performed under ambient temperature and pressure. Although elevated temperature may promote the hydrogen generation rate, additional energy is needed to raise the reaction temperature. The products comprise free of carbon such as carbon monoxide or carbon dioxide and are safe to humans and the environment; the byproducts such as aluminum hydroxide or aluminum oxide may be recycled for further treatments. Further, the products of the hydrogen reaction can maintain the pH of water unchanged or near to neutrality. Method and hydrogen-generating material of the present invention are superior in that a high temperature calcination process is unnecessary for the modifier particles such as TiO₂, and a press process for pressing the metal particle and the modifier together to form pellet also can be omitted. In addition, prior art discloses that a regrinding process for the un-reacted Al is helpful to expose fresh clean surface of aluminum particles thus generating more hydrogen, and the regrinding process may be repeated until all aluminum is consumed; in contrast, the present invention proposes the pitting mechanism reflecting advantage that the metal particles can be totally reacted after the only one, initial milling process.

Notice that in this context the use of the terms a, an, etc. do not denote a limitation of quantity, but rather denote the presence of at least one of the referenced item. In addition, the term “nanoscale” refers to a length within about 1-1000 nm, unless otherwise specified.

Although specific embodiments have been illustrated and described, it will be appreciated by those skilled in the art that various modifications may be made without departing from the scope of the present invention, which is intended to be limited solely by the appended claims.

TABLE 1

| | | Purity | | | | |
|---|---|---|---|---|---|---|
| Precursors | Supplier | (%) | Particle size | | Remark | |
| Al powder (a) | Showa | >99.7 | 45 | μm | 325 | mesh |
| Al powder (h) | Alfa Aesar | >99.8 | 45~380 | μm | 325~40 | mesh |
| Al powder (c) | Alfa Aesar | >99.5 | 45 | μm | 325 | mesh |
| AlO(OH) | Genesis | >99.5 | 15 | nm | | |
| | Nanotech | | | | | |
| | Corp. | | | | | |
| CaO | J. T. Baker | >98.3 | Unavailable | | dissolve in | |
| | Inc. | | | | water | |
| SiO₂ | Local supplier | >99 | 2 | μm | | |
| Al(OH)₃ | Acros | >99 | 600~700 | nm | | |
| α-Al₂O₃ | Alfa Aesar | >99.9 | 650 | nm | | |
| γ-Al₂O₃ | Alfa Aesar | >99.97 | 200~600 | nm | | |
| WO₃ | Alfa Aesar | >99.8 | 10-20 | μm | | |
| Fe₂O₃ | Local supplier | >99 | 500~700 | nm | | |
| TiO₂(P90) | Degussa Ltd. | >99.5 | 14 | nm | | |
| TiO₂(P25) | Degussa Ltd. | >99.5 | 25 | nm | | |
| TiO₂ | Ishihara | >99.74 | 100 | nm | | |
| (PT501A) | Sangyo | | | | | |
| | Kaisha | | | | | |
| TiO₂ | Shimakyu's | >99 | 300~450 | nm | | |
| (Reagent) | Pure | | | | | |
| | Chemicals | | | | | |

TABLE 2

| | | Average H₂ | |
|---|---|---|---|
| Al (1 g):TiO₂ | Total H₂ | generation rate | |
| (P90) | generation | (ml/h · 1 g Al) | Remark |
| 10:1 | 14.5 | 0.8 | |
| 5:1 | 24.6 | 1.4 | |
| 2:1 | 80.2 | 4.5 | |
| 1.5:1 | 155.0 | 8.6 | |
| 1:1 | 516.6 | 28.7 | Effective |
| 1:1.5 | 673.6 | 37.4 | Effective |
| 1:2 | 603.3 | 33.6 | Effective |
| 1:5 | 117.2 | 6.5 | |
| 1:10 | 40.5 | 2.3 | |

TABLE 3

| | Weight | | | | Average H₂ | |
|---|---|---|---|---|---|---|
| | ratio of | | | Total H₂ | generation | |
| Oxide | 1 g Al to | Ball- | | generation | rate | |
| powder | modifier | milling | | (ml) | (ml/h · 1 g Al) | Remark* |
| Al(OH)₃ | 1:1 | No^{#} | | 0 | 0 | Little |
| | | | | | | effect |
| | 1:10 | No | | 1.6 | 0.1 | |
| | 1:20 | No | | 6.1 | 0.34 | |
| | 1:1 | 1 | h | 0 | 0 | |
| AlO(OH) | 1:1 | No | | 364.8 | 20.3 | Effective. |
| | 1:10 | No | | 1057.5 | 58.8 | |
| | 1:20 | No | | 1249.8 | 69.4 | |
| SiO₂ | 1:1 | 1 | h | 39.9 | 2.2 | Less |
| | | | | | | effective |
| | 1:1 | 64 | h | 58.9 | 3.3 | |
| Fe₂O₃ | 1:1 | 1 | h | 35.2 | 2.0 | Less |
| | | | | | | effective |
| WO₃ | 1:1 | 1 | h | 0.76 | 0 | Little |
| | | | | | | effect |
| | 1:1 | 24 | h | 2.95 | 0.2 | |
| α-Al₂O₃ | 1:1 | No | | 4.7 | 0.3 | Little |
| | | | | | | effect |
| | 1:10 | No | | 9.2 | 0.5 | |
| | 1:20 | No | | 4.9 | 0.3 | |
| | 1:1 | 1 | h | 1.2 | 0.1 | |
| | 1:1 | 16 | h | 9.3 | 0.5 | |
| γ-Al₂O₃ | 1:1 | No | | 449.0 | 24.9 | Effective |
| | 1:10 | No | | 433.6 | 24.1 | |
| | 1:20 | No | | 465.3 | 25.8 | |
| | 1:1 | 3 | min | 769.6 | 42.7 | |
| | | by hand | | | | |
| | 1:1 | 7.5 | min | 882.5 | 49.0 | |
| | 1:1 | 1 | h | 381.2 | 21.2 | |
| | 1:1 | 24 | h | 269.8 | 15.0 | Less |
| | 1:1 | 64 | h | 226.0 | 12.6 | Effective |
| CaO | 1:0.5 | No | | 1307 | 217.8 | Very |
| (pH = 11) | | | | | | effective |
| TiO₂, | 1:1 | No | | 381.7 | 21.2 | Effective |
| (P90) | 1:1 | 3 | min | 1021 | 56.7 | |
| | | by hand | | | | |
| | 1:1 | 7.5 | min | 873.9 | 48.6 | |
| | 1:1 | 15 | min | 785.1 | 43.6 | |
| | 1:1 | 30 | min | 639.5 | 35.5 | |
| | 1:1 | 1 | h | 516.6 | 28.7 | |
| | 1:1 | 24 | h | 146.2 | 8.1 | Less |
| | 1:1 | 64 | h | 185.4 | 10.3 | effective |
| TiO₂, | 1:1 | 1 | h | 47.3 | 2.6 | Less |
| (P25) | | | | | | effective |
| | 1:1 | 24 | h | 84.2 | 4.7 | |
| TiO₂, | 1:1 | 1 | h | 32.8 | 1.8 | Less |
| (PT501A) | | | | | | effective |
| | 1:1 | 24 | h | 44.2 | 7.5 | |
| TiO₂ | 1:1 | 1 | h | 31.0 | 1.7 | Less |
| (Reagent) | | | | | | effective |
| | 1:1 | 24 | h | 44.0 | 2.4 | |

*“effective” means that the H₂ generation rate is greater than 20 ml/h per g Al.
“No” means that metal Al powder and modifier were put into tap water without any mixing process.

What is claimed is:

1. A hydrogen-generating material for generating a hydrogen by reacting the hydrogen-generating material with a water, comprising:
a plurality of metal particles selected from the group consisting essentially of aluminum, aluminum alloy, and combination thereof; and
a plurality of modifier particles with an average nanoscale particle size being mixed with the metal particles, wherein the modifier particles comprise group 3 to group 12 transition metal oxide particles.

2. The hydrogen-generating material as recited in claim 1, wherein the group 3 to group 12 transition metal oxide particles comprise period 4 transition metal oxide particles.

3. The hydrogen-generating material as recited in claim 1, wherein the water comprises a tap water or a deionized water, and the modifier particles comprise titanium dioxide (TiO₂) particles whose average particle size is about 15 nanometer for reacting with the tap water, and is about between 300 nm and 450 nm or smaller than about 450 nm for reacting with the deionized water.

4. The hydrogen-generating material as recited in claim 1, wherein the weight ratio of the metal particles to the modifier particles is between about 1:0.5 to about 1:2.

5. The hydrogen-generating material as recited in claim 4, wherein the weight ratio of the metal particles to the modifier particles is between about 1:1 to about 1:1.5.

6. The hydrogen-generating material as recited in claim 1, wherein the metal particles comprise microscale metal particles.

7. The hydrogen-generating material as recited in claim 1, wherein the metal particles comprise nanoscale metal particles.

8. The hydrogen-generating material as recited in claim 1, wherein the modifier particles are selected from a group consisting of titanium dioxide (TiO₂), chromium trioxide (Cr₂O₃), cobalt tetroxide (Co₃O₄), nickel oxide (NiO), iron tetroxide (Fe₃O₄), iron oxide (Fe₂O₃), and combination thereof.

9. The hydrogen-generating material as recited in claim 8, wherein the average particle size of modifier particles is between about 10 nm to about 50 nm.

10. The hydrogen-generating material as recited in claim 1, wherein an oxide layer is naturally deposited on the surface of the metal particles, and a portion of the oxide layer is removed from the metal particles.

11. A method for producing a hydrogen, comprising:
mixing a plurality of metal particles with a plurality of modifier particles to generate a hydrogen-generating material, wherein the metal particles is made of a material selected from the group consisting essentially of aluminum, aluminum alloy, and combination thereof, and the modifier particles comprise group 3 to group 12 transition metal oxide particles; and reacting the hydrogen-generating material with a water to generate products comprising the hydrogen.

12. The method as recited in claim 11, wherein the mixing step comprises a mechanically mixing process, which pulverizes and mixes the metal particles and the modifier particles.

13. The method as recited in claim 12, further comprising:
controlling the duration of the milling process sufficient to completely remove an oxide layer deposited on the surface of the metal particles, such that hydrogen is generated in a relatively short period of time, wherein the end of the relatively short period of time is the time that the surface of the metal particles is encapsulated by a metal oxide byproduct of the products.

14. The method as recited in claim 12, further comprising:
controlling the duration of the milling process to remove a portion of an oxide layer deposited on the surface of each of the metal particles, such that the generation of hydrogen conforms to a pitting mechanism and hydrogen is uniformly generated in a relatively long period of time until the metal particle is totally reacted.

15. The method as recited in claim 11, wherein the water comprises a tap water or a deionized water, and the modifier particles comprise titanium dioxide (TiO₂) particles whose average particle size is about 15 nanometer for reacting with the tap water, and is about between 300 nm and 450 nm or smaller than about 450 nm for reacting with the deionized water.

16. The method as recited in claim 11, wherein the weight ratio of the metal particles to the modifier particles is between about 1:0.5 to about 1:2.

17. The method as recited in claim 16, wherein the weight ratio of the metal particles to the modifier particles is between about 1:1 to about 1:1.5.

18. The method as recited in claim 11, wherein the metal particles comprise microscale or nanoscale metal particles.

19. The method as recited in claim 11, wherein the modifier particles are selected from a group consisting of titanium dioxide (TiO₂), chromium trioxide (Cr₂O₃), cobalt tetroxide (Co₃O₄), nickel oxide (NiO), iron tetroxide (Fe₃O₄), iron oxide (Fe₂O₃), and combination thereof.

20. The method as recited in claim 19, wherein the average particle size of modifier particles is between about 10 nm to about 50 nm.
